(19) United States
(12) Patent Application Publication
(10) Pub. No.: US 2025/0063056 A1
(43) Pub. Date: Feb. 20, 2025

(54) INFORMATION PROCESSING METHOD, ANOMALY DETERMINATION METHOD, AND INFORMATION PROCESSING DEVICE

(71) Applicant: Panasonic Automotive Systems Co., Ltd., Kanagawa (JP)

(72) Inventors: Nobutaka KAWAGUCHI, Osaka (JP); Yuishi TORISAKI, Osaka (JP); Shoichiro SEKIYA, Osaka (JP); Takayoshi ITO, Osaka (JP)

(73) Assignee: Panasonic Automotive Systems Co., Ltd., Kanagawa (JP)

(21) Appl. No.: 18/937,686

(22) Filed: Nov. 5, 2024

Related U.S. Application Data
(63) Continuation of application No. PCT/JP2023/003829, filed on Feb. 6, 2023.

(30) Foreign Application Priority Data
May 30, 2022 (JP) 2022-087376

(51) Int. Cl. H04L 9/40

(52) U.S. Cl. CPC H04L 63/1416; H04L 63/1425

(57) ABSTRACT

An information processing method is executed by an information processing device that detects an attack against a monitored object by communicating with the monitored object. The information processing method includes: obtaining attack information related to an attack against the monitored object; and determining priorities of a plurality of detection rules based on the attack information, and storing the priorities in association with the plurality of detection rules, the plurality of detection rules being used for determining whether an anomaly has occurred in the monitored object when the monitored object is attacked. The priorities indicate at least one of (i) an order in which the plurality of detection rules are used or (ii) whether to use the plurality of detection rules when determining whether an anomaly has occurred in the monitored object.

### CROSS REFERENCE TO RELATED APPLICATIONS

This is a continuation application of PCT International Application No. PCT/JP2023/003829 filed on Feb. 6, 2023, designating the United States of America, which is based on and claims priority of Japanese Patent Application No. 2022-087376 filed on May 30, 2022.

### FIELD

The present disclosure relates to an information processing method, an anomaly determination method, and an information processing device.

### BACKGROUND

Conventionally, systems are available which provide security in communication networks, such as in-vehicle communication networks.

Patent Literature (PTL) 1 discloses a system that includes a module that monitors messages in an in-vehicle communication network, identifies anomalous messages, and transmits data in accordance with the messages to a hub in order to identify anomalous messages in the in-vehicle communication network.

### CITATION LIST

### Patent Literature

PTL 1: Japanese Unexamined Patent Application Publication No. 2015-136107

### SUMMARY

However, the system according to PTL 1 can be improved upon.

In view of this, the present disclosure provides an information processing method capable of improving upon the above related art.

An information processing method according to one aspect of the present disclosure is an information processing method that is executed by an information processing device that detects an attack against a monitored object by communicating with the monitored object. The information processing method includes: obtaining attack information related to an attack against the monitored object; and determining, based on the attack information, priorities of a plurality of detection rules used for determining whether an anomaly has occurred in the monitored object when the monitored object is attacked, and storing the priorities in association with the plurality of detection rules, wherein the priorities indicate at least one of (i) an order in which the plurality of detection rules are used or (ii) whether to use the plurality of detection rules when determining whether an anomaly has occurred in the monitored object.

Some general and specific aspects may be implemented using a system, a method, an integrated circuit, a computer program, or a non-transitory computer-readable recording medium such as a CD-ROM, or any combination of systems, methods, integrated circuits, computer programs, or non-transitory computer-readable recording media.

The information processing method according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram of an information processing system according to an embodiment.

FIG. 2 is a block diagram illustrating a hardware configuration of an information processing device according to the embodiment.

FIG. 3 is a block diagram illustrating a hardware configuration of a vehicle according to the embodiment.

FIG. 4 is a block diagram illustrating a functional configuration of the information processing system according to the embodiment.

FIG. 5 is a flowchart illustrating the processing steps performed by the information processing device according to the embodiment.

FIG. 6 is a flowchart illustrating the processing steps performed by an anomaly determiner according to the embodiment.

FIG. 7 is a block diagram illustrating a functional configuration of an information processing system according to a variation of the embodiment.

FIG. 8 is a flowchart illustrating the processing steps performed by a vehicle according to the variation of the embodiment.

### DESCRIPTION OF EMBODIMENT

### Underlying Knowledge Forming Basis of the Present Disclosure

In a communication network system used in a security operation center (SOC) that detects and analyzes attacks (more specifically, cyber-attacks), when an object to be monitored (monitored object), such as a vehicle, is actually attacked and the system determines whether an anomaly has occurred in the vehicle, the details of an attack are compared with a plurality of detection rules. The comparison process determines, for example, what type of anomaly has occurred in the vehicle.

The detection rules vary depending on the configuration or specifications of the communication network system. The larger the number of monitored objects or anomalies to be detected, the more the details of the attacks are compared with a vast number of detection rules to determine the anomaly of the monitored object.

The communication network system cannot manage all of the vast number of detection rules, depending on the specifications of each device included in the communication network system. For example, depending on the specifications, the communication network system cannot compare all of the vast number of detection rules with the details of the attack to determine whether an anomaly has occurred. Moreover, for example, depending on the specifications, it may take too long for the communication network system to obtain the result of determination when determining an anomaly by using the detection rules. As a result, it may take too long to obtain the result of determination when the detection rules, among a plurality of detection rules, which detect the occurrence of an anomaly that has a particularly serious impact on the monitored object are used.

In addition, unnecessary detection rules may have been set due to designer errors or other reasons, or detection rules for the attacks for which measures have already been taken may remain. In these cases, the details of an attack may be compared with the unnecessary detection rules.

In view of the above, the inventors of the present application have found that by assigning priorities to a plurality of detection rules, for example, the detection rules corresponding to attacks that are likely to be made in the near future are preferentially used to make determinations, or only detection rules with higher priorities are used to make determinations. Specifically, it is desirable for this type of network communication system to improve the performance of determining whether an anomaly has occurred in a monitored object, such as reducing the amount of processing and/or rapidly determining a particularly important anomaly when a monitored object, such as a vehicle, is attacked (specifically, cyber-attacks). The present disclosure provides an information processing method and the like capable of improving the performance of determining whether an anomaly has occurred in a monitored object.

An information processing method according to one aspect of the present disclosure is an information processing method that is executed by an information processing device that detects an attack against a monitored object by communicating with the monitored object. The information processing method includes: obtaining attack information related to an attack against the monitored object; and determining, based on the attack information, priorities of a plurality of detection rules used for determining whether an anomaly has occurred in the monitored object when the monitored object is attacked, and storing the priorities in association with the plurality of detection rules, wherein the priorities indicate at least one of (i) an order in which the plurality of detection rules are used or (ii) whether to use the plurality of detection rules when determining whether an anomaly has occurred in the monitored object.

With this, for example, whether an anomaly has occurred is determined by using detection rules with higher priorities, i.e., the detection rules considered to be particularly important, in preference to the other detection rules. Therefore, for anomalies that are considered to be particularly important, determination results can be obtained rapidly. Moreover, for example, by using only high-priority detection rules, it is possible to rapidly obtain determination results for anomalies that are considered to be particularly important. The low-priority detection rules, i.e., rules that are considered less important, are not used. This leads to a reduced amount of processing. In other words, with the information processing method according to one aspect of the present disclosure, it is possible to improve the performance of determining whether an anomaly has occurred in a monitored object.

Moreover, for example, the information processing method according to one aspect of the present disclosure further includes: determining whether an anomaly has occurred in the monitored object by using the plurality of detection rules in a descending order of the priorities determined, when the monitored object is attacked.

With this, whether an anomaly has occurred is determined by using detection rules with higher priorities, i.e., the detection rules considered to be particularly important, in preference to the other detection rules. Therefore, for anomalies that are considered to be particularly important, determination results can be obtained rapidly.

Moreover, for example, the information processing method according to one aspect of the present disclosure further includes: storing one or more detection rules of the plurality of detection rules in a second storage device that is different from a first storage device that stores the plurality of detection rules, the one or more detection rules each having a priority determined to be at least a predetermined value, in which, when determining whether an anomaly has occurred, the one or more detection rules are used by referring to the second storage device.

With this, by using only high-priority detection rules, it is possible to rapidly obtain determination results for anomalies that are considered to be particularly important. The low-priority detection rules, i.e., rules that are considered to be less important, are not used. This leads to a reduced amount of processing.

Moreover, for example, the attack information includes at least one of (i) sign information that indicates a sign of an attack against the monitored object or (ii) detection information that indicates a result of detection of the attack that has been made against the monitored object.

This allows the priorities of detection rules to be appropriately determined according to the type of attack, the type of monitored object that is the target of the attack (specifically, for example, the types of a plurality of processors included in the monitored object), or the frequency of the attack.

Moreover, for example, the attack information includes information related to a plurality of types of attacks, and the information processing method includes: when the attack information obtained does not include information related to a predetermined type of attack among the plurality of types of attacks for a predetermined period of time, initializing the priorities determined according to the information related to the predetermined type of attack.

For example, when a given type of attack has not been made for a certain period of time, that type of attack is unlikely to be made in the future. Therefore, for example, when the priority of a certain detection rule is increased because information related to a certain type of attack is included in the attack information, and when information related to the certain type of attack is not included in the attack information for a certain period of time, the priority of the certain detection rule is initialized. For example, the priority is decreased by the amount the priority was increased. This makes it possible to appropriately determine priorities when, for example, the details of an attack have changed.

Moreover, an anomaly determination method according to one aspect of the present disclosure is an anomaly determination method that is executed by a vehicle that determines an anomaly upon receiving a detection rule for an attack against the vehicle from an information processing device that manages the detection rule. The anomaly determination method includes: receiving a plurality of detection rules from the information processing device based on attack information related to an attack detected in the vehicle, the plurality of detection rules each being the detection rule; determining, based on priorities, whether an anomaly has occurred in the vehicle due to the attack against the vehicle that has been detected, by using one or more detection rules of the plurality of detection rules, the priorities being determined for the plurality of detection rules; and notifying a result of the determining when the anomaly is determined to have occurred in the vehicle, wherein the priorities indicate at least one of (i) an order in which the plurality of detection rules are used, or (ii) whether to use the plurality of detection rules when determining whether an anomaly has occurred in the monitored object.

With this, for example, whether an anomaly has occurred is determined by using detection rules with higher priorities, i.e., the detection rules considered to be particularly important, in preference to the other detection rules. Therefore, for anomalies that are considered to be particularly important, determination results can be obtained rapidly. Moreover, for example, by using only high-priority detection rules, it is possible to rapidly obtain determination results for anomalies that are considered to be particularly important. The low-priority detection rules, i.e., rules that are considered to be less important, are not used. This leads to a reduced amount of processing. In other words, with the information processing method according to one aspect of the present disclosure, it is possible to improve the performance of determining whether an anomaly has occurred in a vehicle.

An information processing device according to one aspect of the present disclosure is an information processing device that detects an attack against a monitored object by communicating with the monitored object. The information processing device includes: an obtainment circuit that obtains attack information related to an attack against the monitored object; and a determination circuit that determines, based on the attack information, priorities of a plurality of detection rules used for determining whether an anomaly has occurred in the monitored object when the monitored object is attacked, and stores the priorities in association with the plurality of detection rules, wherein the priorities indicate at least one of (i) an order in which the plurality of detection rules are used, or (ii) whether to use the plurality of detection rules when determining whether an anomaly has occurred in the monitored object

This provides the same advantageous effects as the information processing method according to one aspect of the present disclosure.

Some general and specific aspects according to the present disclosure may be implemented using a system, a method, an integrated circuit, a computer program, or a non-transitory computer-readable recording medium such as a CD-ROM, or any combination of systems, methods, integrated circuits, computer programs, or non-transitory computer-readable recording media.

Hereinafter, an embodiment according to the present disclosure will be specifically described with reference to the drawings.

Each exemplary embodiment described below shows a specific example according to the present disclosure. The numerical values, shapes, materials, structural elements, the arrangement and connection of the structural elements, steps, the processing order of the steps etc. shown in the following exemplary embodiment are mere examples, and therefore do not limit the present disclosure. Therefore, among the structural elements in the following exemplary embodiment, those not recited in any one of the independent claims are described as optional structural elements.

### Embodiment

### [Configuration]

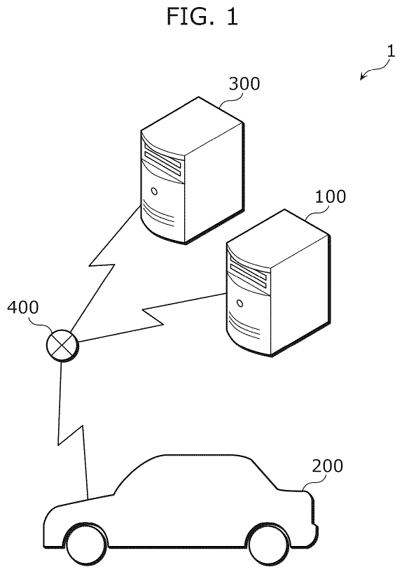

FIG. 1 is a schematic diagram of information processing system 1 that provides information to a vehicle according to an embodiment.

Information processing system 1 is a communication network system that includes information processing device 100, vehicle 200, and cooperative system 300 which are communicatively connected to each other via network 400 such as the Internet. In the present embodiment, information processing system 1 is an in-vehicle communication network system in which information processing device 100 obtains information from vehicle 200 and cooperative system 300, and processes the obtained information.

The number of vehicles 200 and cooperative systems 300 is not particularly limited. Information processing system 1 may include a plurality of vehicles 200. Information processing system 1 may also include a plurality of cooperative systems 300.

Information processing device 100 is a device that detects attacks against a monitored object by communicating with the monitored object. In the present embodiment, information processing device 100 is a device for monitoring the status of vehicle 200. Information processing device 100 is provided in, for example, a monitoring center, such as a security operation center (SOC). Information processing device 100 obtains information (also called detection information) related to attacks (specifically, cyber-attacks) against vehicle 200 detected in vehicle 200, and monitors the status of vehicle 200 based on the obtained detection information. Specifically, information processing device 100 determines the priorities of a plurality of detection rules for determining whether an anomaly has occurred in vehicle 200, based on the obtained detection information. In the present embodiment, information processing device 100 determines, based on the determined priorities, whether an anomaly has occurred in vehicle 200 by using one or more detection rules among the plurality of detection rules. For example, information processing device 100 outputs the result of determination to a notifying device that includes a display that displays images and/or an acoustic device such as a speaker that outputs sound, which are not illustrated in the figures, to cause the notifying device to notify an administrator of the result of determination.

Information processing device 100 is, for example, a communication interface for communicating with vehicle 200 and cooperative system 300, a nonvolatile memory in which a program is stored, a volatile memory that is a temporary storage area for executing the program, input and output ports for transmitting and receiving signals, and a computer, such as a server, realized by a processor that executes the program.

Vehicle 200 is a vehicle that transmits detection information to information processing device 100. Vehicle 200 is an example of a monitored object. More specifically, each of telematics control unit (TCU) 21, a plurality of electronic control units (ECUs) 22, storage 23, and communication bus 24, which are to be described below and included in vehicle 200, is an example of a monitored object (i.e., an object to be monitored), and each of a plurality of detection sensors 25 is an example of an object that performs monitoring (see FIG. 3). Vehicle 200 is, for example, any vehicle, such as a motorcycle or a four-wheeled vehicle. In the present embodiment, vehicle 200 is an automated vehicle that can be driven automatically. Vehicle 200 does not have to be an automated vehicle.

Cooperative system 300 is a device for monitoring the status of vehicles in a region different from information processing device 100. In other words, information processing device 100 and cooperative system 300 are similarly configured, and monitor the status of vehicles in different regions. Information processing device 100 and cooperative system 300 transmit, to each other, information (also called shared information) related to attacks against vehicles and the like that are being monitored by information processing device 100 and cooperative system 300. Information processing device 100 determines the priorities of a plurality of detection rules based on the detection information obtained from vehicle 200 and the attack information including the shared information obtained from cooperative system 300.

Among the SOCs described above, cooperative system 300 may be a SOC for IT that monitors office networks, or a SOC for operational technology (OT) that monitors networks in factories that produce industrial devices, etc.

The shared information may include, for example, information, which is related to attacks against vehicles, on computers connected to the Internet and information entered by an administrator managing information processing device 100 or cooperative system 300.

Cooperative system 300 is, for example, a communication interface for communicating with information processing device 100 and vehicle 200, a non-volatile memory in which a program is stored, a volatile memory that is a temporary storage area for executing the program, input and output ports for transmitting and receiving signals, and a computer such as a server realized by a processor that executes the program.

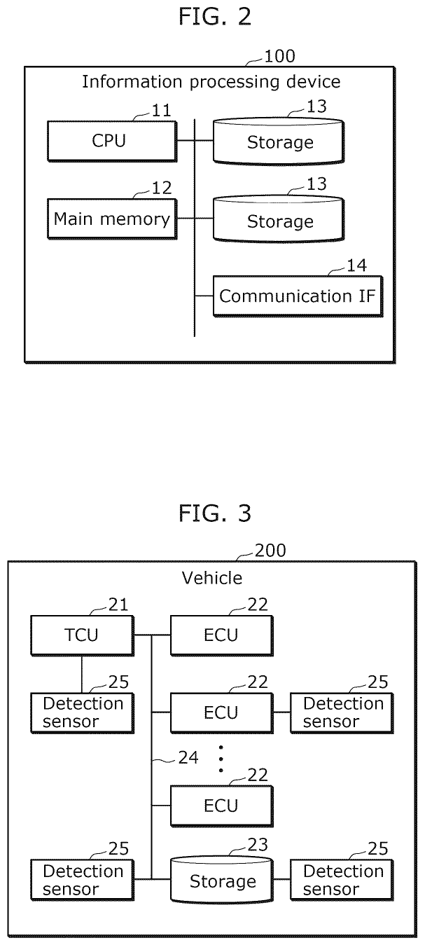

FIG. 2 is a block diagram illustrating a hardware configuration of information processing device 100 according to the embodiment.

Information processing device 100 includes central processing unit (CPU) 11, main memory 12, storage 13, and communication interface (IF) 14 as a hardware configuration.

CPU 11 is a processor that executes control programs stored in storage 13 and the like.

Main memory 12 is a volatile storage area used as a work area for CPU 11 to execute control programs.

Storage 13 is a non-volatile storage area that holds control programs and contents. Storage 13 is realized by, for example, hard disk drive (HDD) or solid stated drive (SSD).

The number of storages 13 may be one or plural. In the present embodiment, information processing device 100 includes a plurality of storages 13.

Communication interface (IF) 14 is a communication interface that communicates with vehicle 200 and cooperative system 300 via network 400. Communication IF 14 may be, for example, a wired local area network (LAN) interface or a wireless LAN interface. Communication IF 14 is not limited to the LAN interface, but can be any communication interface that can establish a communication connection with a communication network.

FIG. 3 is a block diagram illustrating an example of a hardware configuration of a vehicle according to the embodiment.

Vehicle 200 includes, as a hardware configuration, TCU 21, a plurality of ECUs 22, storage 23, communication bus 24, and a plurality of detection sensors 25.

TCU 21 is a communication unit that allows vehicle 200 to communicate wirelessly with network 400. TCU 21 is a communication unit that includes a cellular module that is compatible with the specifications of the mobile communication network.

ECUs 22 are electronic control units (ECUs) that execute control on the devices included in vehicle 200. Examples of such devices include an engine, motor, meter, transmission, brake, steering, power window, and air conditioner. At least one of ECUs 22 may be a control circuit that controls autonomous driving of vehicle 200. Each of ECUs 22 may be provided for a different one of these various devices. Each of ECUs 22 may include a storage (non-volatile storage area), not illustrated in the figures, which stores the program to be executed by ECU 22. The storage is, for example, a non-volatile memory.

Storage 23 is a non-volatile storage area that holds control programs and the like. Storage 23 is realized by, for example, HDD or SSD.

Communication bus 24 is a dedicated communication path to which TCU 21, ECUs 22, and storage 23 are connected to allow vehicle 200 to perform control on multiple devices. Communication bus 24 is realized by, for example, CAN or in-vehicle Ethernet.

Detection sensors 25 include a function to monitor whether TCU 21, ECUs 22, storage 23, or communication bus 24 have been attacked. At least one of detection sensors 25 is, for example, a host-based intrusion detection system (HIDS) and monitors TCU 21, ECUs 22, and storage 23 which are hardware connected to communication bus 24. Moreover, for example, at least one of detection sensors 25 is a network-based intrusion detection system (NIDS), and monitors communication bus 24. Detection sensors 25 may be networked to communication bus 24 as stand-alone devices, or may be integrated with TCU 21, ECUs 22, and storage 23.

Next, a functional configuration of information processing device 100 and vehicle 200 of information processing system 1 will be described.

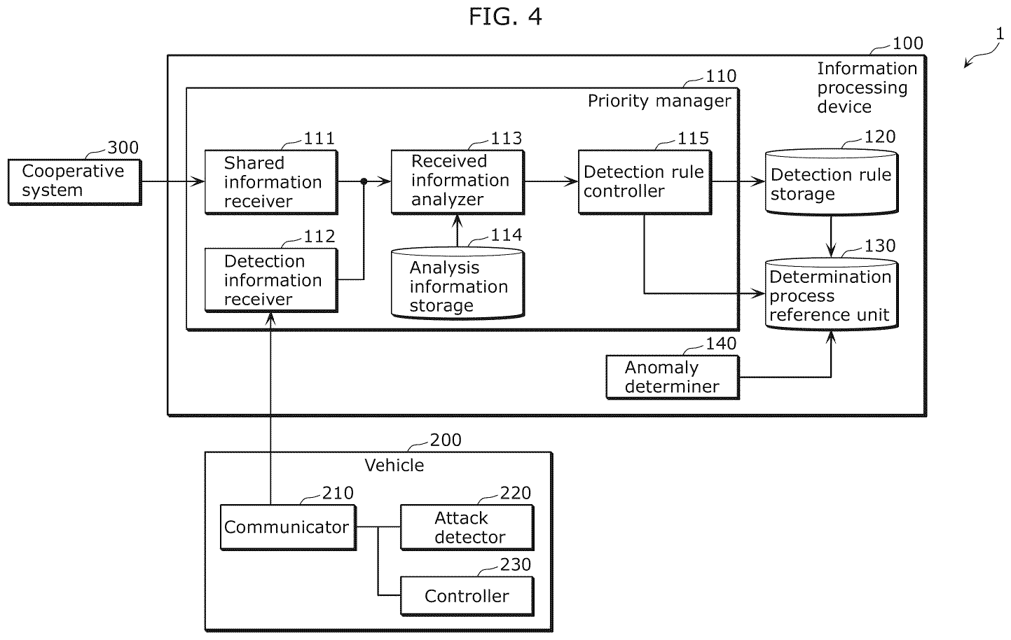

FIG. 4 is a block diagram illustrating a functional configuration of information processing system 1 according to the embodiment. In FIG. 4, network 400 is not illustrated.

First, a configuration of information processing device 100 will be described.

Information processing device 100 includes priority manager 110, detection rule storage 120, determination process reference unit 130, and anomaly determiner 140.

Priority manager 110 manages (more specifically, determines) the priorities of the detection rules stored in detection rule storage 120.

Priority manager 110 includes shared information receiver 111, detection information receiver 112, received information analyzer 113, analyzed information storage 114, and detection rule controller 115.

Shared information 111 receiver receives shared information from cooperative system 300. Shared information receiver 111 is realized, for example, by communication IF 14.

Detection information receiver 112 receives detection information from vehicle 200. Detection information receiver 112 is realized, for example, by communication IF 14.

Shared information receiver 111 and detection information receiver 112 may be realized by the same communication interface or by different communication interfaces.

Received information analyzer 113 is a processor that obtains attack information related to attacks against vehicle 200, and determines, based on the attack information, the priorities of the detection rules used to determine whether an anomaly has occurred in vehicle 200 when vehicle 200 is attacked. Specifically, received information analyzer 113 obtains shared information via shared information receiver 111 and detection information via detection information receiver 112, and analyzes the obtained information to determine the priorities of the detection rules. Received information analyzer 113 is an example of an obtainer and a determiner.

The priorities indicate at least one of (i) the order in which the detection rules are used or (i) whether to use detection rules (more specifically, detection rules corresponding to the determined priorities) when determining whether an anomaly has occurred in vehicle 200.

The attack information includes, for example, at least one of (i) sign information that indicates signs of an attack against vehicle 200 or (ii) detection information that indicates the result of detection of an attack against vehicle 200.

The sign information is information that indicates signs of an attack against vehicle 200, and is, for example, information included in the shared information obtained from cooperative system 300. For example, the sign information is information used for determining (estimating) the type of an attack and how likely the occurrence of that type of attack will be, and is information that indicates that vehicle 200 has not been attacked but is likely to be attacked in the future, or information that indicates that vehicle 200 is being attacked but is unlikely to be attacked in the future.

For example, the sign information includes information indicating that attack detector 220, such as a network-based intrusion detection system (NIDS) that monitors the navigation system used by the vehicle, has been detecting “header anomaly” more often than usual. For example, when received information analyzer 113 obtains such information, it is assumed that attacks that attempt to intrude vehicle 200 by means of unauthorized login via port scan of the navigation system will start to increase. Accordingly, received information analyzer 113 increases the priorities of the detection rules for such types of attacks.

For example, the sign information includes information that indicates software vulnerabilities. For example, when received information analyzer 113 obtains such information, it is assumed that attacks against vehicle 200 that includes TCU 21, ECUs 22, and storage 23 in which such software is employed will start to increase. Accordingly, received information analyzer 113 increases the priorities of the detection rules related to such types of attacks and the priorities of the detection rules related to TCU 21, ECUs 22, and storage 23 in which the software is employed.

For example, the sign information includes information that indicates vulnerabilities caused by specification defects in communication protocols. For example, when received information analyzer 113 obtains such information, it is assumed that attacks against vehicle 200 that includes communication bus 24 with the communication protocols will start to increase. Accordingly, received information analyzer 113 increases the priorities of the detection rules related to such types of attacks and the detection rules related to communication bus 24 with the communication protocols.

For example, the sign information includes information that indicates an increase in denial-of-service (DOS) attacks against various servers in cooperative system 300, such as intelligent transport systems (ITSs). For example, when received information analyzer 113 obtains such information, it is assumed that message spoofing attacks, in which a legitimate server is shut down by DoS attacks and messages are sent from the spoofed server, will start to increase. Accordingly, received information analyzer 113 increases the priorities of detection rules related to such types of attacks.

For example, the sign information includes information that indicates that an attack campaign against Country A or Company B has been published on the Web. For example, when received information analyzer 113 obtains such information, it is assumed that attacks against the vehicle models produced and/or sold by Country A or Company B will start to increase. Accordingly, received information analyzer 113 increases the priorities of the detection rules for such types of attacks and for the corresponding types of vehicle 200.

Detection information is information that indicates the details of the attack detected in vehicle 200 (for example, type of attack, timing of the attack, and which one of TCU 21, ECUS 22, storage 23, and communication bus 24 has been attacked).

Received information analyzer 113, for example, analyzes the detection information to generate analysis information that includes target type information, attack type information, frequency information, and the like.

The target type information indicates, for example, whether one of TCU 21, ECUs 22, storage 23, and communication bus 24 has been attacked. The target type information may include information that indicates the type of vehicle, such as vehicle type, and/or information that indicates the types of ECUs 22, storage 23, and communication bus 24.

The attack type information is, for example, information that indicates the type of attack made against vehicle 200.

The frequency information is information that indicates the number of times vehicle 200 has been attacked. Specifically, the frequency information is information that indicates the number of times each of TCU 21, ECUs 22, storage 23, and communication bus 24 included in vehicle 200 has been attacked. Moreover, the frequency information may include the types of ECU 22s, storage 23, and communication bus 24 that have been attacked and the number of times each type of attack has been made.

Information processing device 100 may obtain information detected in the vehicle monitored by cooperative system 300, such as target type information, attack type information, and frequency information, as sign information included in the shared information.

Received Information analyzer 113 determines the priorities of the detection rules based on the attack information that includes the above information. In the present embodiment, received information analyzer 113 compares the obtained attack information with the previously obtained attack information, determines the signs of future attacks against vehicle 200 based on the result of comparison, and determines the priorities based on the result of determination.

For example, it is assumed that a plurality of detection rules are defined as follows.
Detection rule 1: attack a occurs at node A, and attack b occurs at node B.
Detection rule 2: attack a occurs at node A, attack b occurs at node B, and attack c occurs at node C.
Detection rule 3: attack d occurs at node A and attack b occurs at node B.
Detection rule 4: attack d occurs at node A, attack b occurs at node B, and attack c occurs at node C.
Detection rule 5: attack d occurs at node A and attack a occurs at node B.

A node is a monitored object, and is, for example, TCU 21, ECU 22, or storage 23. For example, node A and node B are ECUs 22 that are different from each other. Moreover, for example, attack a to attack d are different types of attacks. A node can be replaced by communication bus 24 that can be a target of an attack.

For example, when attack information includes information indicating that attack a has occurred (or there are signs of occurrence of attack a) at node A, received information analyzer 113 increases the priorities of detection rule 1 and detection rule 2.

For example, when the attack information includes information indicating that attack a has occurred (or there are signs of occurrence of attack a) at node B, received information analyzer 113 increases the priority of detection rule 5.

The way the priority is increased (the value added to the priority) may be changed according to the level of impact (for example, risk level) caused when an anomaly occurs in vehicle 200 due to an attack. Moreover, for example, a priority may be set for each type of attack. For example, as the priority of detection rule 1 described above, the priority that is in accordance with attack a and the priority that is in accordance with attack b may be determined. Thus, for example, the priority may be expressed as a multidimensional value.

Moreover, the impact level is not particularly limited, but may be arbitrarily determined in advance.

Received information analyzer 113 may also reduce the priorities of the detection rules based on the obtained attack information. For example, attack information includes information related to a plurality of types of attacks, such as attack a to attack d described above. When, for a predetermined period of time, the obtained attack information does not include information related to a predetermined type of attack among a plurality of types of attacks, received information analyzer 113 initializes the priorities determined according to the information related to the predetermined type of attack. For example, when, after determining the priority of detection rule 1 to be “5”, the obtained attack information does not include any information indicating that attack a or attack b has been made, or any information indicating signs of these attacks for a predetermined period of time, received information analyzer 113 changes (initializes) the priority of detection rule 1 to the initial value (for example, to “0”).

Furthermore, for example, it is assumed that received information analyzer 113 determines the priority of detection rule 1, which originally had a priority of “0”, to “5”, by adding “2” based on information related to attack a, and further adding “3” based on information related to attack b. For example, when the obtained attack information after this does not include information indicating that attack “a” has been made or information indicating signs of attack a for a predetermined period of time, received information analyzer 113 may change the priority of detection rule 1 to “3” or “0”.

The predetermined period of time is not particularly limited, and may be arbitrarily determined in advance.

Moreover, for example, received information analyzer 113 may reduce the priorities of the detection rules, when attack information (specifically, for example, sign information) includes information indicating that attack detector 220 such as NIDS is detecting “header anomalies” less frequently, information indicating that countermeasures against software vulnerabilities have been completed, information indicating that DOS attacks against various servers of cooperative system 300 such as ITS are decreasing, or information indicating that the end of the attack campaign has been published on the Web.

As described above, received information analyzer 113 updates the priorities of the detection rules based on the obtained attack information.

Analysis information storage 114 is a storage device that stores the analysis results of attack information (analysis information) analyzed by received information analyzer 113. The analysis information is, for example, the result of comparison between the obtained attack information with the previously obtained attack information.

Analysis information storage 114 may store the obtained attack information, the determined priorities, or the amount of change in priority that has been changed (updated).

Analysis information storage 114 is realized, for example, by storage 13.

Detection rule controller 115 is a processor that records (stores) the priorities of the detection rules determined by received information analyzer 113 in detection rule storage 120 or the like in association with the detection rules. Detection rule controller 115 stores, in determination process reference unit 130, one or more detection rules among the plurality of detection rules stored in detection rule storage 120, based on the priorities determined by received information analyzer 113. For example, detection rule controller 115 stores, among the detection rules, one or more detection rules with priorities determined to be at least a predetermined value in determination process reference unit 130 that is different from detection rule storage 120 in which the detection rules are stored. For example, detection rule controller 115 stores the detection rules with priorities determined to be at least the predetermined value in determination process reference unit 130 in association with the determined priorities.

Detection rule controller 115 may copy the detection rules that are stored in detection rule storage 120 and have priorities determined to be at least a predetermined value, and store the detection rules in determination process reference unit 130 without association with the priorities.

The predetermined value is not particularly limited, and may be arbitrarily determined in advance.

Detection rule storage 120 is a storage device that stores a plurality of detection rules. Detection rule storage 120 is an example of a first storage device. Detection rule controller 115 may associate the determined priority with the detection rule with each other for storage in detection rule storage 120.

Detection rule storage 120 is realized, for example, by storage 13.

Determination process reference unit 130 is a storage device that stores the detection rules for which priorities with a predetermined value or higher has been determined. Determination process reference unit 130 is an example of a second storage device. Determination process reference unit 130 is realized, for example, by storage 13. In the present embodiment, detection rule storage 120 and determination process reference unit 130 are realized by different storages 13.

Analysis information storage 114 may be, for example, realized by the same storage 13 as detection rule storage 120, or by a storage different from detection rule storage 120 and determination process reference unit 130. Analysis information storage 114, detection rule storage 120, and determination process reference unit 130 may be realized by the same storage (i.e., single storage).

Anomaly determiner 140 is a processor that determines whether an anomaly has occurred in vehicle 200 due to attacks against vehicle 200 by using one or more of the detection rules based on the priorities determined for the detection rules. In the present embodiment, anomaly determiner 140 determines whether an anomaly has occurred in vehicle 200 by using one or more detection rules with reference to determination process reference unit 130. In other words, anomaly determiner 140 determines whether an anomaly has occurred in vehicle 200 due to attacks against vehicle 200 by using the detection rules stored in determination process reference unit 130. For example, when vehicle 200 is attacked (for example, when the attack information includes information indicating that vehicle 200 has been attacked), anomaly determiner 140 determines whether an anomaly has occurred in vehicle 200 by using the detection rules in descending order of the priorities determined.

The determination result is, for example, output to the notifying device (not illustrated in the figure), to notify the administrator.

The processors such as received information analyzer 113, detection rule controller 115, and anomaly determiner 140 are realized, for example, by CPU 11 and main memory 12.

A functional configuration of vehicle 200 will be described next.

Vehicle 200 includes communicator 210, attack detector 220, and controller 230.

Communicator 210 exchanges information with information processing device 100 via network 400. Specifically, communicator 210 transmits detection information that indicates the result of detection obtained by attack detector 220 to information processing device 100.

For example, communicator 210 is realized by TCU 21.

Communicator 210 may, for example, transmit, to information processing device 100, log information that indicates the control state of vehicle 200, the detected values of the sensors included in vehicle 200, or the like, and the operating status information of vehicle 200.

Attack detector 220 is, for example, a NIDS, and is a processor that monitors data flowing through communication bus 24 connected to ECUs 22. Specifically, attack detector 220 detects attacks against vehicle 200 (more specifically, ECUs 22) by monitoring the data flowing through communication bus 24 connected to ECUs 22. Attack detector 220 (more specifically, a plurality of detection sensors 25) transmits detection information that indicates the result of detection of the attack to information processing device 100 via communicator 210 (more specifically, TCU 21, ECUs 22 with external communication functions, and hardware specialized for external communication functions that is not illustrated in vehicle 200).

Attack detector 220 is realized by at least one of detection sensors 25.

Controller 230 is a processor that controls the operation of vehicle 200 by controlling the engine, steering wheel, and the like (not illustrated) included in vehicle 200.

Controller 230 is realized by, for example, at least one of ECUs 22.

Information processing device 100 may obtain operating status information indicating the operating status of vehicle 200 from vehicle 200. The operating status information may be generated by vehicle 200 when the operating status of vehicle 200 changes and transmitted to information processing device 100 each time the operating status information is generated. The operating status information may be generated by vehicle 200 on a regular basis and transmitted to information processing device 100 each time the operating status information is generated, regardless of changes in operating status of vehicle 200. The operating status information is information in which the vehicle information of vehicle 200 is associated with the operating status of vehicle 200. When obtaining the operating status information, information processing device 100 updates the operating status of vehicle 200 specified by the vehicle information included in the operating status information to the operating status included in the operating status information. In this way, information processing device 100 may manage the operating status of vehicle 200.

For example, when vehicle 200 is attacked, information processing device 100 may transmit, to vehicle 200, control instructions that are in accordance with the attack. Vehicle 200 may execute control in accordance with the obtained control instructions.

### [Processing Steps]

Next, processing steps performed by information processing device 100 will be described.

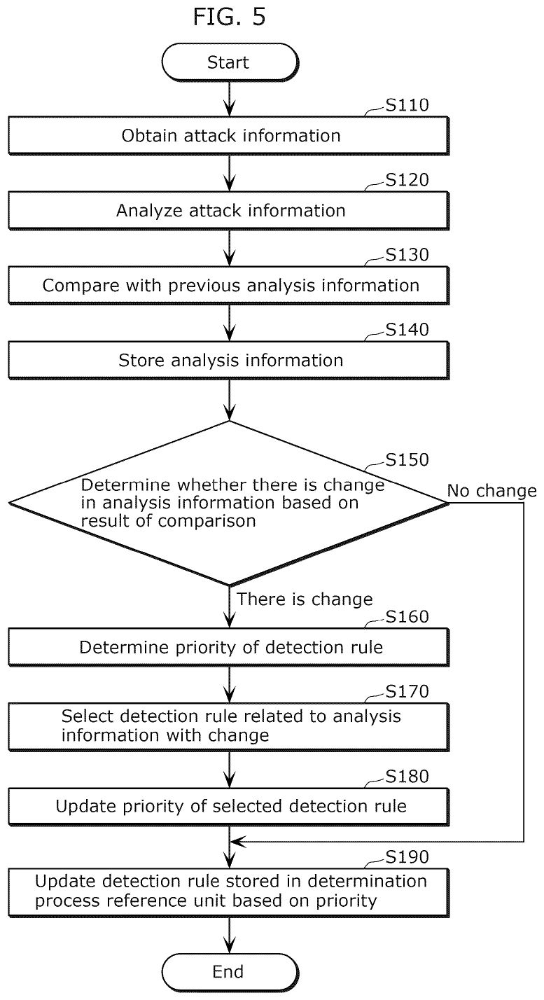

FIG. 5 is a flowchart illustrating the processing steps performed by information processing device 100 according to the present embodiment.

First, received information analyzer 113 obtains attack information from cooperative system 300 and vehicle 200 via shared information receiver 111 and detection information receiver 112 (S110).

Next, received information analyzer 113 analyzes the obtained attack information (S120). Received information analyzer 113, for example, analyzes attack information to generate target type information, attack type information, and frequency information as analysis information.

Next, received information analyzer 113 compares the generated analysis information with the previous analysis information stored in analysis information storage 114 (S130).

Next, received information analyzer 113 stores the generated analysis information in analysis information storage 114 (S140).

Next, received information analyzer 113 determines whether there is a change in the analysis information based on the result of comparison in step S140 (S150). For example, received information analyzer 113 determines whether the number of times attack a has been made, as indicated by the analysis information generated in step S120, has increased or decreased relative to the number of times attack a has been made as indicated by the previous analysis information.

When determining that there is a change in the analysis information (“there is a change” in S150), received information analyzer 113 determines the priorities of the detection rules stored in detection rule storage 120 (S160). For example, when determining that the number of attacks of attack a indicated by the analysis information generated in step S120 has increased compared to the number of attacks of attack a indicated by the previous analysis information, received information analyzer 113 determines to increase the priorities of the detection rules for attack a.

Next, detection rule controller 115 selects, from among the detection rules stored in detection rule storage 120, a detection rule that has a priority different from the priority determined by received information analyzer 113 in step S160, that is, the detection rule that has a change in priority (S170).

Next, detection rule controller 115 updates (changes) the priority of the detection rule selected in step S170 to the priority determined by received information analyzer 113 in step S160 (S180).

Next, detection rule controller 115 updates the detection rules stored in determination process reference unit 130 based on the priorities (S190). Detection rule controller 115, for example, changes the detection rules stored in determination process reference unit 130 to the detection rules with priorities determined in step S160 to be at least a predetermined value.

Information processing device 100, for example, repeats the above processes on a regular basis.

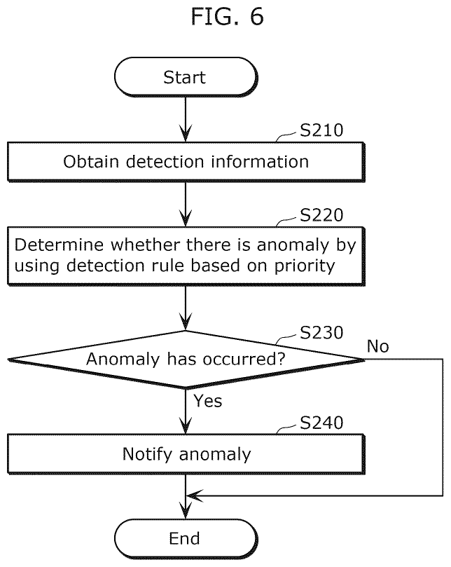

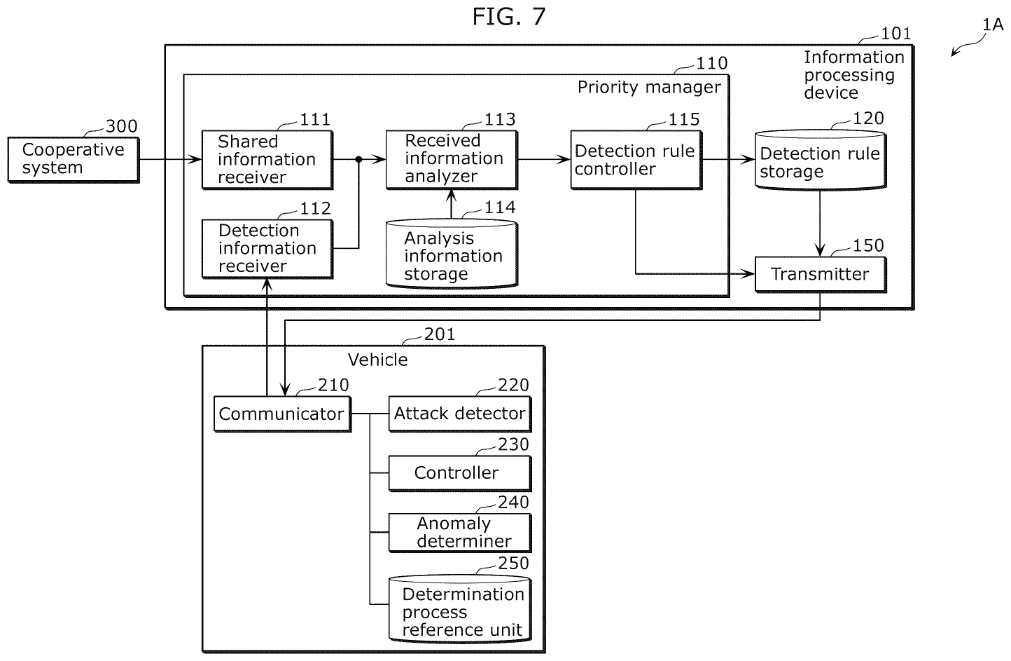

FIG. 6 is a flowchart illustrating the processing steps performed by anomaly determiner 140 according to the present embodiment.

First, anomaly determiner 140 obtains detection information (S210). Anomaly determiner 140 may obtain detection information from vehicle 200 via detection information receiver 112, or obtain, from analysis information storage 114 or determination process reference unit 130, the detection information stored in analysis information storage 114 or determination process reference unit 130 by received information analyzer 113 or detection rule controller 115.

Next, anomaly determiner 140 determines whether or not an anomaly has occurred in vehicle 200 by using the detection information and the detection rules based on the priorities (S220). For example, anomaly determiner 140 determines whether an anomaly has occurred in vehicle 200 by using detection rules in descending order of priorities with reference to determination process reference unit 130.

When determining that an anomaly has occurred in vehicle 200 (Yes in S230), anomaly determiner 140 notifies the administrator of the occurrence of an anomaly by outputting information that indicates that an anomaly has occurred to a notifying device or the like (S240).

On the other hand, when determining that no anomaly has occurred in vehicle 200 (No in S230), anomaly determiner 140 ends the processing.

Anomaly determiner 140, for example, repeats the above processes on a regular basis.

When No in step S230, anomaly determiner 140 may notify the administrator of the occurrence of no anomaly by outputting information indicating that no anomaly has occurred to a notifying device or the like.

When Yes in step S230, information processing device 100 may transmit, to vehicle 200, control information for causing vehicle 200 to perform processing in accordance with the details of the anomaly.

### Variations

Anomaly determiner 140 and determination process reference unit 130 may be included in vehicle 200.

FIG. 7 is a block diagram illustrating a functional configuration of information processing system 1A according to a variation of the embodiment.

In the variation, the differences from the embodiment described above will be mainly described, and descriptions for substantially similar configurations and processing may be omitted.

Information processing system 1A includes information processing device 101, vehicle 201, and cooperative system 300. Vehicle 201 is an example of a monitored object.

Information processing device 101 includes priority manager 110, detection rule storage 120, and transmitter 150.

Transmitter 150 is a communication interface for communicating with vehicle 201. For example, transmitter 150 is realized by communication IF 14.

Transmitter 150 may be realized by the same communication IF as shared information receiver 111 and detection information receiver 112, or a different communication IF.

Transmitter 150 may be a wired communication interface or a wireless communication interface.

Detection rule controller 115, for example, transmits the detection rule with a priority determined to at least a predetermined value to vehicle 201 via transmitter 150, in association with the priority.

Vehicle 201 receives detection rules for attacks against vehicle 201 from information processing device 101 that manages the detection rules to determine an anomaly. Vehicle 201 includes communicator 210, attack detector 220, controller 230, anomaly determiner 240, and determination process reference unit 250.

In a similar manner to anomaly determiner 140, anomaly determiner 240 is a processor that determines whether an anomaly has occurred in vehicle 201 due to an attack against vehicle 201 by using one or more of the detection rules based on the priorities determined for the detection rules. In the variation, anomaly determiner 240 determines whether an anomaly has occurred in vehicle 201 by using one or more detection rules with reference to determination process reference unit 250. For example, when vehicle 201 is attacked (for example, when attack detector 220 detects an attack), anomaly determiner 240 determines whether an anomaly has occurred in vehicle 201 by using detection rules in descending order of the priorities determined. Specifically, anomaly determiner 240 receives a plurality of detection rules from information processing device 101 based on the attack information detected in vehicle 201 via communicator 210. Anomaly determiner 240 then determines whether an anomaly has occurred in vehicle 201 due to the detected attack against vehicle 201 by using one or more of the detection rules, based on the priorities determined for the detection rules. For example, when an attack is detected in vehicle 201, anomaly determiner 240 transmits a signal to information processing device 101 requesting that the detection rules be transmitted, thereby receiving the detection rules and storing the received detection rules in determination process reference unit 250.

For example, anomaly determiner 240 may receive the detection rules from information processing device 101 at the time when vehicle 201 is driven, such as when the engine is turned on.

Anomaly determiner 240 is realized by, for example, at least one of ECUs 22.

The result of determination obtained by anomaly determiner 240 is, for example, transmitted to information processing device 101 via communicator 210, and output to a notifying device (not illustrated) connected to information processing device 101 to notify the administrator. The result of determination obtained by anomaly determiner 240 may, for example, be output to a notifying device (not illustrated) included in vehicle 201 to notify the passengers of vehicle 201. For example, controller 230 may perform control on vehicle 201 based on the result of determination.

Determination process reference unit 250 is a storage device that stores the detection rules with priorities determined to be at least a predetermined value, in a similar manner to determination process reference unit 130. Determination process reference unit 250 is an example of a second storage device. Determination process reference unit 250 is realized, for example, by storage 23. For example, anomaly determiner 240 obtains the detection rules with priorities determined to be at least a predetermined value and the priorities of the detection rules, which have been transmitted from information processing device 101 via communicator 210, and stores the detection rules and the priorities in determination process reference unit 250.

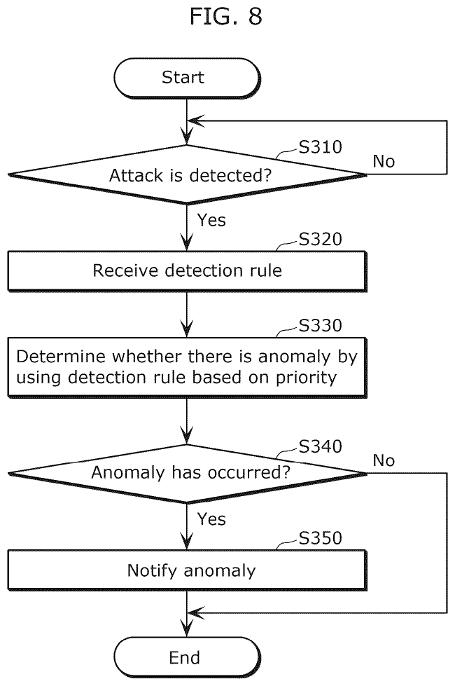

FIG. 8 is a flowchart illustrating the processing steps performed by vehicle 201 according to the variation of the embodiment.

First, attack detector 220 determines whether an attack against vehicle 201 has been detected (S310).

When determining that no attack against vehicle 201 has been detected (No in S310), attack detector 220 repeats the process in step S310.

On the other hand, when attack detector 220 determines that an attack against vehicle 201 has been detected (Yes in S310), anomaly determiner 240 receives detection rules from information processing device 101 via communicator 210 (S320). As described above, for example, anomaly determiner 240 receives the detection rules from information processing device 101 by transmitting, to information processing device 101, a signal requesting that the detection rules be transmitted.

Next, anomaly determiner 240 determines, based on the priorities, whether an anomaly has occurred in vehicle 201 by using the result of detection obtained by attack detector 220 and the detection rules (S330). For example, anomaly determiner 240 determines whether an anomaly has occurred in vehicle 201 by using detection rules in descending order of the priorities with reference to determination process reference unit 250.

When determining that an anomaly has occurred in vehicle 201 (Yes in S340), anomaly determiner 240 transmits information indicating that an anomaly has occurred to information processing device 101 via communicator 210, for example. The information is output to the notifying device (not illustrated) connected to information processing device 101 to notify the administrator of the occurrence of the anomaly (S350).

On the other hand, when determining that no anomaly has occurred in vehicle 201 (No in S340), anomaly determiner 240 ends the processes.

Anomaly determiner 240, for example, repeats the above processes on a regular basis.

When No in step S340, anomaly determiner 240 may notify the administrator that no anomaly has occurred by transmitting, to information processing device 101, information indicating that no anomaly has occurred.

When Yes in step S340, controller 230 may perform processing in accordance with the details of the anomaly.

### CONCLUSION

As described above, the information processing method according to the embodiment is an information processing method that is executed by an information processing device that detects an attack against a monitored object by communicating with the monitored object. The information processing method includes: obtaining (S110) attack information related to an attack against the monitored object; and determining, based on the attack information, priorities of a plurality of detection rules used for determining whether an anomaly has occurred in the monitored object when the monitored object is attacked, and storing (for example, S160 to S180) the priorities in association with the plurality of detection rules. The priorities indicate at least one of (i) an order in which the plurality of detection rules are used or (ii) whether to use the plurality of detection rules when determining whether an anomaly has occurred in the monitored object.

The information processing method is, for example, a method executed by information processing device 100. Examples of the monitored object include vehicle 200 and vehicle 201.

With this, for example, whether an anomaly has occurred is determined by using detection rules with higher priorities, i.e., the detection rules considered to be particularly important, in preference to the other detection rules. Therefore, for anomalies that are considered to be particularly important, determination results can be obtained rapidly. Moreover, for example, by using only high-priority detection rules, it is possible to rapidly obtain determination results for anomalies that are considered to be particularly important. The low-priority detection rules, i.e., rules that are considered to be less important, are not used. This leads to a reduced amount of processing. In other words, with the information processing method according to one aspect of the present disclosure, it is possible to improve the performance of determining whether an anomaly has occurred in a monitored object.

Moreover, for example, the information processing method according to the embodiment, further includes: determining (S220) whether an anomaly has occurred in the monitored object by using the plurality of detection rules in a descending order of the priorities determined, when the monitored object is attacked.

With this, whether an anomaly has occurred is determined by using detection rules with higher priorities, i.e., the detection rules considered to be particularly important, in preference to the other detection rules. Therefore, for anomalies that are considered to be particularly important, determination results can be obtained rapidly.

Moreover, for example, the information processing method according to the embodiment, further includes: storing (S190) one or more detection rules of the plurality of detection rules in a second storage device that is different from a first storage device that stores the plurality of detection rules, the one or more detection rules each having a priority determined to be at least a predetermined value, in which, when determining (S220) whether an anomaly has occurred, the one or more detection rules are used by referring to the second storage device.

The first storage device is, for example, detection rule storage 120. The second storage device is, for example, a determination process reference unit.

With this, by using only high-priority detection rules, it is possible to rapidly obtain determination results for anomalies that are considered to be particularly important. The low-priority detection rules, i.e., rules that are considered to be less important, are not used. This leads to a reduced amount of processing.

Moreover, for example, the attack information includes at least one of (i) sign information that indicates a sign of an attack against the monitored object or (ii) detection information that indicates a result of detection of the attack that has been made against the monitored object.

This allows the priorities of detection rules to be appropriately determined according to the type of attack, the type of the monitored object that is the target of the attack (specifically, for example, the types of a plurality of processors included in the monitored object), or the frequency of the attack.

Moreover, for example, the attack information includes information related to a plurality of types of attacks, and the information processing method includes: when the attack information obtained does not include information related to a predetermined type of attack among the plurality of types of attacks for a predetermined period of time, initializing the priorities determined according to the information related to the predetermined type of attack.

For example, when a given type of attack has not been made for a certain period of time, that type of attack is unlikely to be made in the future. Therefore, for example, when the priority of a certain detection rule is increased because information related to a certain type of attack is included in the attack information, and when information related to the certain type of attack is not included in the attack information for a certain period of time, the priority of the certain detection rule is initialized. For example, the priority is decreased by the amount the priority was increased. This makes it possible to appropriately determine priorities when, for example, the details of an attack has changed.

Moreover, an anomaly determination method according to an embodiment is an anomaly determination method that is executed by a vehicle that determines an anomaly upon receiving a detection rule for an attack against the vehicle from an information processing device that manages the detection rule. The anomaly determination method includes: receiving (S320) a plurality of detection rules from the information processing device based on attack information related to an attack detected in the vehicle, the plurality of detection rules each being the detection rule; determining (S330), based on priorities, whether an anomaly has occurred in the vehicle due to the attack against the vehicle that has been detected, by using one or more detection rules of the plurality of detection rules, the priorities being determined for the plurality of detection rules; and notifying (for example, S350) a result of the determining when the anomaly is determined to have occurred in the vehicle (for example, Yes in S340), in which the priorities indicate at least one of (i) an order in which the plurality of detection rules are used, or (ii) whether to use the plurality of detection rules when determining whether an anomaly has occurred in the monitored object.

The anomaly determination method is, for example, a method executed by vehicle 201.

With this, whether an anomaly has occurred is determined by using detection rules with higher priorities, i.e., the detection rules that are considered to be particularly important, in preference to the other detection rules. Therefore, for anomalies that are considered to be particularly important, determination results can be obtained rapidly. Moreover, for example, by using only high-priority detection rules, it is possible to rapidly obtain determination results for anomalies that are considered to be particularly important. The low-priority detection rules, i.e., rules, which are considered to be less important, are not used. This leads to a reduced amount of processing. In other words, with the information processing method according to one aspect of the present disclosure, it is possible to improve the performance of determining whether an anomaly has occurred in a vehicle.

Moreover, the information processing device according to one aspect of the present disclosure is an information processing device that detects an attack against a monitored object by communicating with the monitored object. The information processing device includes: an obtainer that obtains attack information related to an attack against the monitored object; and a determiner that determines, based on the attack information, priorities of a plurality of detection rules used for determining whether an anomaly has occurred in the monitored object when the monitored object is attacked, and stores the priorities in association with the plurality of detection rules, wherein the priorities indicate at least one of (i) an order in which the plurality of detection rules are used, or (ii) whether to use the plurality of detection rules when determining whether an anomaly has occurred in the monitored object.

The information processing device is, for example, information processing device 100 or information processing device 101. The obtainer and the determiner are, for example, received information analyzer 113 and detection rule controller 115, respectively.

This provides the same advantageous effects as the information processing method according to one aspect of the present disclosure.

### OTHER EMBODIMENTS

Although the information processing device and the like according to one or more aspects has been described based on the embodiment above, the present disclosure is not limited to the embodiment. Various modifications of the embodiment that may be conceived by those skilled in the art may be included in the present disclosure as long as these do not depart from the essence of the present disclosure.

For example, in the embodiment, the case where vehicles 200 and 201 are the monitored objects has been described. However, the monitored objects may be, for example, a mobile object such as a ship or airplane, production equipment provided in a factory, etc., or a computer that controls these objects. In other words, the present disclosure may be applied to an in-vehicle communication network system, or to a communication network system that includes production equipment provided in a factory, etc. and a server that communicates with the production equipment.

The number of ECUs included in the vehicle is not particularly limited.

Moreover, for example, in the embodiment, the processes executed by a specific processor may be executed by another processor. The order of the plurality of processes may be changed or a plurality of processes may be executed in parallel.

Moreover, for example, each of the structural elements in the above-described embodiment may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or a semiconductor memory. Here, the program for realizing each device according to the embodiment is a program that causes a computer to execute each step in the flowcharts in, for example, FIG. 5, FIG. 6, or FIG. 8.

The following cases are also included in the present disclosure.
(1) At least one device described above is specifically a computer system including a microprocessor, a ROM, a RAM, a hard disk unit, a display unit, a keyboard, a mouse, and the like. The RAM or the hard disk unit stores a computer program. The at least one device achieves its function by the microprocessor operating according to the computer program. Here, a computer program is formed of combinations of instruction codes indicating commands to a computer to achieve a predetermined function.
(2) Part or all of the structural elements included in the at least one device may be configured by a single system large scale integration (LSI). The system LSI is an ultra-multifunctional LSI manufactured by integrating a plurality of structural elements on a single chip, and specifically, is a computer system including a microprocessor, a ROM, a RAM, and the like. A computer program is stored in the RAM. The system LSI achieves its function by the microprocessor operating according to the computer program.
(3) Part or all of the structural elements included in the at least one device may be configured with an integrated circuit (IC) card removable from the device or a single module. The IC card or the module is a computer system including a microprocessor, a ROM, a RAM, and the like. The IC card or the module may include the above described ultra-multifunctional LSI. The IC card or the module achieves its function by the microprocessor operating according to the computer program. The IC card or the module may be tamper resistant.
(4) The present disclosure may be implemented by the method described above. Moreover, the method may be a computer program implemented by a computer or a digital signal configured from the computer program.

Moreover, the present disclosure may be a computer program or a digital signal recorded on a computer-readable recording medium, such as a flexible disk, a hard disk, a compact disc (CD)-ROM, a DVD, a DVD-ROM, a DVD-RAM, a BD (Blu-ray (registered trademark) Disc), and a semiconductor memory. Moreover, the present disclosure may be the digital signal recorded on these recording media.

Moreover, the present disclosure may transmit the computer program or digital signal via an electronic communication line, a wireless or wired communication line, a network represented by the Internet, a data broadcast, and the like.

Moreover, the program or the digital signal may be recorded on a recording medium and transferred, or the program or the digital signal may be transferred via the network or the like to be implemented by another independent computer system.

While the embodiment have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-087376 filed on May 30, 2022, and PCT International Application No. PCT/JP2023/003829 filed on Feb. 6, 2023.

### INDUSTRIAL APPLICABILITY

The present disclosure is applicable to, for example, information processing devices that monitor cyber-attacks in in-vehicle communication networks.

1. An information processing method that is executed by an information processing device that detects an attack against a monitored object by communicating with the monitored object, the information processing method comprising:
obtaining attack information related to an attack against the monitored object; and
determining, based on the attack information, priorities of a plurality of detection rules used for determining whether an anomaly has occurred in the monitored object when the monitored object is attacked, and storing the priorities in association with the plurality of detection rules,
wherein the priorities indicate at least one of (i) an order in which the plurality of detection rules are used or (ii) whether to use the plurality of detection rules when determining whether an anomaly has occurred in the monitored object.

2. The information processing method according to claim 1, further comprising:
determining whether an anomaly has occurred in the monitored object by using the plurality of detection rules in a descending order of the priorities determined, when the monitored object is attacked.

3. The information processing method according to claim 1, further comprising:
storing one or more detection rules of the plurality of detection rules in a second storage device that is different from a first storage device that stores the plurality of detection rules, the one or more detection rules each having a priority determined to be at least a predetermined value,
wherein, when determining whether an anomaly has occurred, the one or more detection rules are used by referring to the second storage device.

4. The information processing method according to claim 1,
wherein the attack information includes at least one of (i) sign information that indicates a sign of an attack against the monitored object or (ii) detection information that indicates a result of detection of the attack that has been made against the monitored object.

5. The information processing method according to claim 1,
wherein the attack information includes information related to a plurality of types of attacks, and
the information processing method comprises:
when the attack information obtained does not include information related to a predetermined type of attack among the plurality of types of attacks for a predetermined period of time, initializing the priorities determined according to the information related to the predetermined type of attack.

6. An anomaly determination method that is executed by a vehicle that determines an anomaly upon receiving a detection rule for an attack against the vehicle from an information processing device that manages the detection rule, the anomaly determination method comprising:
receiving a plurality of detection rules from the information processing device based on attack information related to an attack detected in the vehicle, the plurality of detection rules each being the detection rule;
determining, based on priorities, whether an anomaly has occurred in the vehicle due to the attack against the vehicle that has been detected, by using one or more detection rules of the plurality of detection rules, the priorities being determined for the plurality of detection rules; and
notifying a result of the determining when the anomaly is determined to have occurred in the vehicle,
wherein the priorities indicate at least one of (i) an order in which the plurality of detection rules are used, or (ii) whether to use the plurality of detection rules when determining whether an anomaly has occurred in the monitored object.

7. An information processing device that detects an attack against a monitored object by communicating with the monitored object, the information processing device comprising:
an obtainment circuit that obtains attack information related to an attack against the monitored object; and
a determination circuit that determines, based on the attack information, priorities of a plurality of detection rules used for determining whether an anomaly has occurred in the monitored object when the monitored object is attacked, and stores the priorities in association with the plurality of detection rules,
wherein the priorities indicate at least one of (i) an order in which the plurality of detection rules are used, or (ii) whether to use the plurality of detection rules when determining whether an anomaly has occurred in the monitored object.
